(19) United States
(12) Patent Application Publication
(10) Pub. No.: US 2005/0216547 A1
(43) Pub. Date: Sep. 29, 2005

(54) System for organizing advertisements on a web page and related method

(76) Inventors: Russell Alan Foltz-Smith, Santa Monica, CA (US); Steven Gertz, Ontario, CA (US); James Carpenter, Arcadia, CA (US); Ask Bjoern Hansen, West Hollywood, CA (US); James Alan Low, Upland, CA (US); Emad Fanous, Burbank, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/797,464

(22) Filed: Mar. 10, 2004

(51) Int. Cl. G06F 15/16; G06F 17/60

(52) U.S. Cl. 709/200; 709/219; 705/14

(57) ABSTRACT

A system including a search engine, an advertiser server, and a user computer. The search engine server has a first computer-readable medium containing information for a search provider's web page. The advertiser server is coupled to the search engine server and has a second computer-readable medium containing information for an advertiser's web page. The user computer is coupled to the search engine and the advertiser's server, and the user computer having a monitor that is configured to display web pages. The search provider's web page, when displayed on the monitor, includes ads with each ad including a link to an advertiser's web page. An advertiser is an entity whose ad is displayed on the search provider's web page. A position of each ad on the search provider's web page is dependent upon whether the search provider is due payment from the advertiser.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

A compact disc is included containing computer program code listings pursuant to 37 C.F.R. 1.52(e) and is hereby incorporated by reference in its entirety. The compact disc includes the following four files: AdGlobs.pm, created on Mar. 8, 2004, and 11 kilobytes in size; AdLimits.pm, created on Mar. 8, 2004, and 3 kilobytes in size; FeatureAd.pm, created on Mar. 8, 2004, and 9 kilobytes in size; and PFPOptomizationCalcsFromCustomerSystems.sql, created on Mar. 8, 2004, and 32 kilobytes in size.

### BACKGROUND OF THE INVENTION

1. Field of the Invention

The invention relates generally to the field of Internet web pages. In particular, the invention relates to a system and method for organizing advertisements on an Internet web page.

2. Description of Related Art

The Internet is a world-wide network that includes thousands of interconnected computers that share electronic information. This shared information is made available at Internet web sites (“web sites”), which can be accessed by a user's computer. Web browser (“browser”) software, e.g., Netscape Navigator or Microsoft's Internet Explorer, running on the user's computer facilitates both the location of the web sites and the display, on the user computer's monitor, of Internet web pages (“web pages”) on which the shared information is displayed. The web pages are rendered in HyperText Markup Language (“HTML”), and the displayed information can include, for example, text, images, graphics, and multimedia content, e.g., audio and video data, and computer software.

The user can access and view the information displayed on a web page, by typing the desired web page's Internet address, called a Uniform Resource Locator (“URL”), into the browser using the user computer's keyboard. After the user types in a request for a particular URL, and the user submits the URL request (e.g., by pressing the enter key on the user computer's keyboard), the browser sends the URL request over the Internet to a server that is named by the URL. The server is a remote computer system where web page information is stored, and that is accessible from other computers via the Internet. The server, in turn, sends the web page information back to the user computer's browser, which displays the web page on the user computer's monitor. During the transfer of information between the user's computer and the server where the web page information is stored, the information can pass through various intermediate servers, routers, and switches.

After the web page information has been retrieved from the server, and the web page has been displayed on the user's computer, the user, in most cases, can select (“click on”) one or more hypertext links (“links”) included on the web page. The user clicks on a link by positioning an on-screen cursor over the link using a mouse, and clicking the mouse. While the present discussion focuses on the selection of links using a mouse, the user can use other computer input/output devices to select a link. When the user clicks on the link, the URL for the web page associated with the link is provided to the user computer's browser program, which, in turn, accesses the server where the web page information is stored. Then, the web page information is transferred from the server to the user's computer where the web page is displayed. Thus, each link provides an automated method for the user to enter the URL of another web page, and to retrieve that web page for display on the user's computer, without having to type the URL for each web page into the browser.

During the 1990's, businesses began to add their own web sites to the Internet. Businesses also began to display advertisements (“ads”) for their products, services, and web sites on commercial web pages. Currently, web page ads can appear as graphical objects, e.g., banners, blocks, or tiles, on a web page. In many cases, these ads include links that a user can click on to access the advertiser's web pages, the information for which is stored in a memory or other computer-readable storage medium included in a server, i.e., the advertiser server. Thus, the ad serves as a click-through point to additional sources of information about the advertiser's business.

Internet search provider web sites are web sites that include commercial web pages for the display of advertisers' ads and associated links. A sponsor is an advertiser that has a financial agreement with the search provider regarding the display of the sponsor's ad. In contrast, a non-sponsor is an advertiser whose ads are displayed on the search provider's web page without financial benefit to the search provider. Thus, a non-sponsor's ad is displayed on the search provider's web page free of charge.

Search provider web sites provide the user with the ability to perform searches, or queries, for information stored in web pages. For example, the user can use the search provider's web site to perform a search for a particular product, service, or advertiser's web page. The results of these searches are documented on the search provider's web page that is displayed on the user's computer monitor. The search results, in most cases, include many advertisers' ads and corresponding links to the advertisers' web pages. The ads are presented to the user in hopes of inducing the user to select a sponsor's link from the multitude of links documented on the search provider's web page.

In some cases, the search provider is due a fee from a sponsor each time a user clicks on a link associated with the sponsor's ad included on the search provider's web page. Thus, a sponsor pays the search provider for its services based on a cost-per-click (“CPC”) basis, e.g., 10¢ per click. If a user clicks on one of the sponsors' links displayed on a search provider's web page, the user's selection is stored in a log kept by the search provider's server. At end of a billing cycle, the search provider bills each sponsor based on the number of clicks logged for the sponsor's ad during the billing cycle multiplied by the CPC.

A search provider often has more ads than can be displayed on the search provider's web page. When deciding which ads to display, the search provider can use a metric called the click-through rate (“CTR”), which is the number of clicks on links included in an ad divided by the number of times the ad was displayed for user consideration. Currently, search providers do not attempt to display ads on their web pages that are near a user's location, even though, the CTR for an ad would likely be higher for ads where the business has a location near the user. Accordingly, there is a need for a system and method where the search provider's web page includes geo-relevant ads for businesses near the user. The present invention satisfies this need.

### SUMMARY OF THE INVENTION

A system and method is provided that organizes geo-relevant ads on a search provider's web page so as to optimize the CTR for each sponsor's ads. Embodiments of the present invention include a system having a search engine, an advertiser server, and a user computer. The search engine server has a first computer-readable medium containing information for a search provider's web page. The advertiser server is coupled to the search engine server, and has a second computer-readable medium containing information for an advertiser's web page. The user computer is coupled to the search engine server and the advertiser's server. The user computer has a monitor that is configured to display web pages. The search provider's web page, when displayed on the monitor, includes ads, with each ad including a link to an advertiser's web page. An advertiser is an entity whose ad is displayed on the search provider's web page. A position of each ad on the search provider's web page is dependent upon whether the search provider is due payment from the advertiser.

In other, more detailed features of the invention, the position of the ad on the search provider's web page is dependent upon whether a link included in an ad has received a predetermined number of clicks within a predetermined period of time. A sponsor is an advertiser that has a financial agreement with the search provider regarding the inclusion of the sponsor's ad on the search provider's web page. A non-sponsor is an advertiser whose ad is displayed on the search provider's web page free of charge. Non-sponsors' ads are displayed in a region of the search provider's web page below another region of the search provider's web page where sponsors' ads are displayed. The search provider is due a fee from a sponsor every time a user selects a link associated with the sponsor's ad displayed on the search provider's web page.

In other, more detailed features of the invention, the sponsor's ad has associated with it a cap amount, which is the maximum amount of money that a sponsor can be billed by the search provider for the sponsor's ad within a billing cycle. A location where the sponsor's ad is displayed on the search provider's web page is influenced by a difference between the cap amount and a total accrued debt owed by the sponsor to the search provider for the sponsor's ad. The sponsor's ad is located within the region of the search provider's web page with non-sponsors' ads when the total accrued debt owed by the sponsor to the search provider for the sponsor's ad equals the cap amount. The sponsor can change the cap amount.

Another exemplary embodiment of the invention is a first computer-readable medium included in a search engine server. The first computer-readable medium contains a program configured to interact with a database stored in a second computer-readable medium also included in the search engine server. The search engine server is configured to couple to an advertiser server having a third computer-readable medium containing information for an advertiser's web page. The search engine server is configured to couple to a user computer having a monitor that is configured to display a web page. The program includes information used to generate a search provider's web page. The search provider's web page is displayed on the monitor and includes ads that are stored in the database. Each ad includes a link to an advertiser's web page, where an advertiser is an entity whose ad is displayed on the search provider's web page. An advertiser is an entity whose ad is displayed on the search provider's web page. A sponsor is an advertiser that has a financial agreement with the search provider regarding the inclusion of the sponsor's ad on the search provider's web page. The search provider is due a fee from the sponsor every time a user selects a link included in the sponsor's ad displayed on the search provider's web page. The sponsor's ad has associated with it a cap amount, which is the maximum amount of money that a sponsor can be billed by the search provider for the sponsor's ad within a billing cycle. A location where the sponsor's ad is displayed on the search provider's web page is influenced by a difference between the cap amount and a total accrued debt owed by the sponsor to the search provider for the sponsor's ad.

An exemplary method according to the invention is a method for organizing ads on a search provider's web page. Information related to the search provider's web page is stored in a first computer-readable medium, which is included in a search engine server. The information related to the search provider's web page is configured to interact with advertiser information in an advertiser database stored in a second computer-readable medium, which also is included in the search engine server. An advertiser is an entity having an ad that is displayed on the search provider's web page. The search engine server is configured to couple to an advertiser server having a third computer-readable medium containing information for an advertiser's web page. The search engine server is configured to couple to a user computer having a monitor that is configured to display a web page. Each sponsor's ad has associated with it a cap amount, which is the maximum amount of money that a sponsor can be billed by the search provider for the sponsor's ad within a billing cycle. The method includes performing a category search using the search engine server for ads included in the advertiser database, creating a list of sponsors' ads based on results of the category search, and positioning the sponsors' ads on the search provider's web page based on a difference between the cap amount and a total accrued debt owed by the sponsor to the search provider for the sponsor's ad.

In other, more detailed features of the invention, the method also includes calculating a geographic region of consideration, and removing all sponsor ads from the list of sponsors' ads when the respective sponsor's business location is outside of the geographic region of consideration. The geographic region of consideration can be a circle having a center point and a radius, wherein the radius is multiplied by a market multiplier factor, which varies as a function of a location of the center point.

In other, more detailed features of the invention, the method additionally includes calculating a pacing factor, and comparing a random number, having a value between zero and one, to the pacing factor for each sponsor's ad and displaying the sponsor's ad on the search provider's web page only if the pacing factor is greater than the random number.

In other, more detailed features of the invention, the method further includes sorting the sponsors' ads and displaying the sponsors' ads on the search provider's web page according to the CPC multiplied by the CTR associated with each sponsor's ad, or calculating a sorting factor and sorting the sponsors' ads and displaying the sponsors' ads on the search provider's web page according to the sorting factor, displaying non-sponsors' ads in a region of the search provider's web page below another region of the search provider's web page where sponsors' ads are displayed, and positioning the sponsor's ad within a region of the search provider's web page with non-sponsors' ads when the total accrued debt owed by the sponsor to the search provider for the sponsor's ad equals the cap amount.

Other features of the invention should become apparent from the following description of the preferred embodiments taken in conjunction with the accompanying drawings, which illustrate, by way of example, the principles of the invention.

### BRIEF DESCRIPTION OF THE DRAWINGS

FIG. 1 is a block diagram of a system according to a preferred embodiment of the present invention.

FIG. 2 is a printout of a search provider's web page generated by a preferred embodiment of the present invention.

FIG. 3 is a flow diagram of a method according to preferred embodiments of the present invention.

FIG. 4a-c are tables that include data generated from a preferred embodiment of the present invention.

### DETAILED DESCRIPTION OF THE PREFERRED EMBODIMENTS

The present invention is a system and method for searching a database containing advertiser data, generating a list of ads based on the advertiser data and the distance between a location selected by the user and each advertiser's business location, and organizing and displaying the list of ads on a search provider's web page based the advertiser's data and the distance between the user's location and each advertiser's business location. The list of ads is organized and displayed so as to optimize the likelihood that a user will click on the links associated with specific sponsors' ads. Thus, the system and method influences the position of the ads and links included on the search provider's web page.

The location of an ad's position on the search provider's web page and the manner in which the ad is displayed for the user's consideration can greatly influence the user's interest in the ad, and the subsequent likelihood of the user clicking on links associated with the ad. It is believed that ads appearing at the top of a web page are more likely to viewed by the user. Other factors can also affect the user's interest in an ad, for example, the images and/or graphics included in the ad and the background color of the ad. Each advertiser ultimately wants its ad to be seen more frequently, and the number of clicks on the links associated with its ad to be optimal.

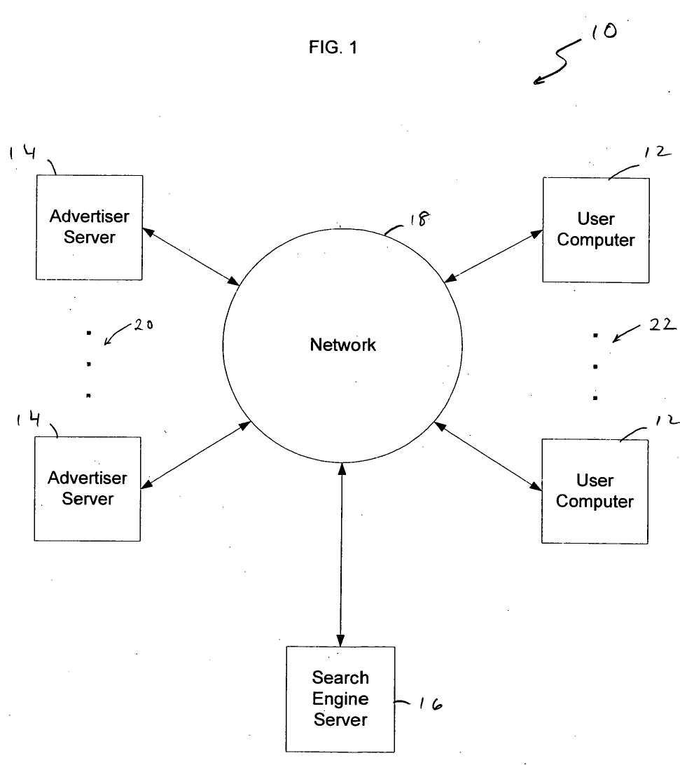

FIG. 1 is a block diagram illustrating a system 10 according to the present invention. The system includes two user computers 12, two advertiser servers 14, and a search engine server 16, all of which are inter-coupled by a network 18, e.g., the Internet. While the following discussion will focus on the use of the system in the context of the Internet, it is to be understood that the system can be used in other types of computer networks, e.g., local-area networks, wide-area networks, and regional networks. Even though, only one search engine server is depicted in FIG. 1, it is to be understood that the system can include two or more search engine servers. Also, while only two user computers, and two advertiser servers are depicted in FIG. 1, it should be understood that the system can include three or more user computers, and three or more advertiser servers, as indicated by the series of dots 20 and 22, respectively, between the two advertiser servers and the two user computers. Furthermore, it should be understood that each of the user computers, advertiser servers, and search engine servers can include more than one computer or server. For instance, embodiments of the present invention include a search engine server having three different servers (not shown), with each of the three servers configured to perform different functions handled by the search engine server.

Each user computer 12 can be a personal computer, workstation, or other computer system. Each user computer can include one or more computer processors (not shown); memories (not shown); input/output devices (not shown), e.g., a mouse, a keyboard, and a monitor configured to display web pages; and network interfaces (not shown), e.g., a modem or network interface card, which facilitate communication between each user computer and the network. Similarly, each server 14 and 16 can include one or more computer processors (not shown), memories (not shown), input/output devices (not shown), and network interfaces (not shown), which facilitate communication between each server and the network. The network 18 facilitates communication between the user computers, advertiser servers, and search engine server. All communication on the network can be performed following the HyperText Transfer Protocol (“HTTP”), or some other network communication protocol known in the art, e.g., File Transfer Protocol (“FTP”).

An advertiser server 14 includes an advertiser's web page information which is stored in a memory (not shown), or other computer-readable storage medium (not shown) within the advertiser server. Similarly, the search engine server 16 includes a search provider's web page information and an advertiser database, which are stored in one or more memories (not shown), or other computer-readable storage media (not shown) within the search engine server.

The advertiser database contains information regarding sponsors, non-sponsors, and their ads. For example, the advertiser database can include the following: a unique identifier for each advertiser's business, and the name, street address, telephone number, and website address for each advertiser's business. Also, the advertiser database can include additional information related to each advertiser, for example, user opinions regarding the advertiser's business, images of the business location, and whether the business is a sponsor or a non-sponsor. For sponsors, the advertiser database also can include the sponsor's account identification number; the sponsor's account balance; the sponsor's cap amount, which is the maximum amount of money that the sponsor can owe the search provider for the ad during a predetermined period of time, or billing cycle, e.g., the cap can be $2,000 per month; the sponsor's billing rate per click, or CPC, e.g., 10¢ per click; the number of clicks recorded for links associated with each sponsor's ad during the predetermined period of time; and a calculated CTR. The CTR varies over time, and the value of the CPC can change, so the CTR and CPC values are updated in the advertiser database by the search engine server 16 on a regular, predetermined basis, for example, on a nightly basis. Each advertiser, whether it is a sponsor or non-sponsor, can have information related to multiple ads and multiple business locations stored in the advertiser database.

A user wanting to access the search provider's web page would first enter the URL for the search provider's web page into the browser running on the user's computer 12. Then, the browser would transfer the user's request, via the network 18, to the search engine server 16 that holds the information for the search provider's web page. Next, the search provider's web page information is transferred from the search engine server to the user's computer, and the search provider's web page is displayed on the user's computer monitor (not shown).

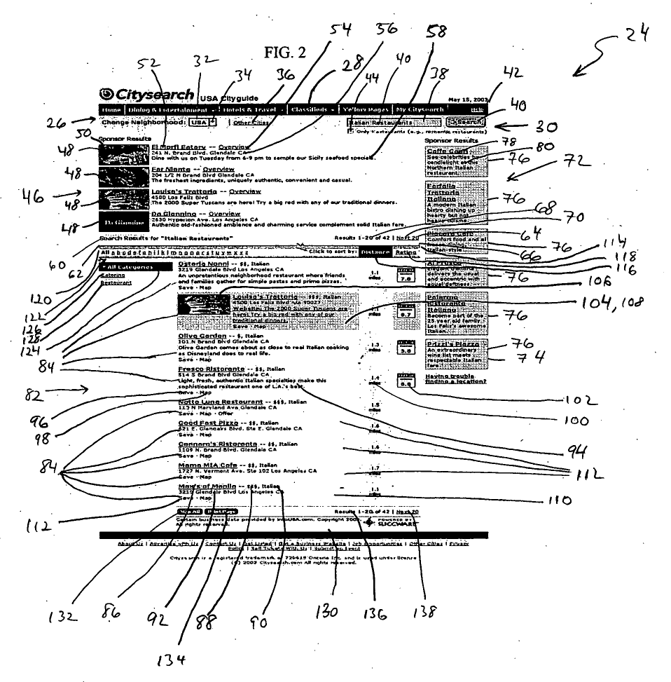

FIG. 2 is a printout of a search provider's web page 24 according to the present invention that is displayed on a user computer's monitor (not shown) as a function of a program stored in a memory (not shown) or other computer-readable storage medium (not shown) included in the search engine server 16. The program is configured to interact with an advertiser database, and the program includes information used to generate the search provider's web page.

The search provider's web page 24 can be subdivided into four regions. A first region 26, located at the top 28 of the web page, is where the filter settings 30 are located. In particular, the first region includes a change neighborhood field 32, which includes a drop-down window 34 for selecting the country or geographic region for a category search. The first region also includes a link 36, which the user can click on to search the advertiser database for businesses in other cities.

The first region 26 of the search provider's web page 24 includes a search field 38, within which the user can type a category 40, e.g., Italian restaurant, that is to be searched by the search engine server 16. After typing the category into the search field, the user clicks on the search button 40, which is located in the upper-right corner 42 of the web page, using the mouse (not shown), or by pressing the enter key (not shown) on the user's computer keyboard (not shown), to transmit the search request from the browser on the user's computer 12 to the search engine server. Next, as discussed below, the search engine server collects the search results, prioritizes the results, and sends the prioritized results back to the user's computer for display on the monitor (not shown). The category search can be limited to apply only to restaurants if a checkbox 44, located below the category field, is selected.

A second region 46 of the search provider's web page 24, which is located below the first region 26, displays a portion of the search results for sponsors' ads. As shown in FIG. 2, sponsor's ads 48, each including an image/graphic 50 (which also is a link), business name link 52, overview link 54, address 56, and brief description 58, are displayed for four different sponsors in the second region. As discussed later in this document, the location of each of the ads in the second region of the web page is determined based on an optimization algorithm. By selecting the business name link displayed in a sponsor's ad, web page information for the sponsor automatically is requested from the sponsor's server 14, the web page information is transferred from the sponsor's server to the user's computer 12, and the sponsor's web page is displayed on the user's computer monitor (not shown) using the browser. If the user selects the overview link, the search engine server transfers information stored on the search engine server 16 about the sponsor to the user's computer, where it is displayed on the monitor.

Text 60 at the bottom, left-hand side 62 of the second region 46 displays the terms included in the category search in quotes. Text 64 at the bottom, right-hand side 66 of the second region displays the number of the search results 68, and a link 70, which the user can click on to view additional search results.

A third region 72 of the search provider's web page 24 is located below the first region 26, and to the right of the second region 46, along the right-hand side 74 of the web page. The third region includes other sponsors ads 76, however, these sponsors' ads merely include the sponsors' business name link 78, which is a link to the sponsor's web page, and a brief description of the sponsor's business 80. As discussed later in this document, the location of each of the ads in the third region of the web page is determined based on an optimization algorithm.

The fourth region 82 of the search provider's web page 24 is located below the second region 46, and to the left of the third region 72. The fourth region of the web page includes ads 84 that display the business name link 86; an indication 88 of the average cost to the user of the goods and/or services provided by the business; the business type 90, e.g., Italian restaurant; the business address 92; in some cases, a brief description 94 of the business; a link 96 to save the ad; and a link 98 to a map that displays the business location. Also in the fourth region of the web page is the distance 100 to the advertiser's business location. Also, for selected ads, a rating 102 of the advertiser's good or services is locate to the right of the distance to the advertiser's business location. The rating is calculated by averaging rating values provided by users to the search engine server 16.

When a sponsor's ad 104 is displayed in the fourth region 82, it additionally can include a graphic image 106, and the background 108 of the ad can be highlighted by a color other than that used for the background 110 of the non-sponsor ads 112. Accordingly, in addition to a sponsor's ads varying in format from a non-sponsor's ad, a sponsor's ad can vary in format and content depending upon whether the sponsor's ad is displayed in the second, third, or fourth regions 46, 72, and 82, respectively, of the search provider's web page 24.

At the top, right-hand side 114 of the fourth region, the user can click on the words “distance” 116 or “rating” 118 to sort the ads 84 displayed in the fourth region 82 according to distance or rating, respectively. At the top, left-hand side 120 of the fourth region, the user can select letters 122 to view all businesses that satisfy the category search according to the first letter of the business name. Also, at the top, left-hand side of the fourth region, below the letters, is a drop-down menu 124 from which the user can select other search categories, e.g., catering 126 and restaurant 128, that are related to the original category search terms. Also, the bottom 130 of the fourth region includes a “map all” button 132, which allows the user to map all of the business locations for the businesses, and a “print pages” button 134, which allows the user to print the current web page 24 displayed on the user's computer monitor. In addition, the bottom of the fourth region includes text 136 that displays the number of the search results, and a link 138, which the user can click on to view additional search results.

On the search provider's web page 24, a user can define a coverage area, for example, a neighborhood, zip code, or specific address that is of interest for search purposes. As discussed previously, after the user types in his or her category search request, that request is transferred from the user's computer 12 to the search engine server 16, where the search request is processed. The search engine server reviews the terms included in the category search request and compares those terms to the name of business categories included in the advertiser database. If the terms included in the category search request do not match any of the business categories included in the advertiser database, then no ads are displayed on the search provider's web page. However, if the terms included in the category search do match one or more of the business categories, then the search engine server will consider the advertisers' ads associated with the matched business categories for inclusion in the search provider's web page.

Each coverage area has its own conceptual “geographic region of consideration,” which can be, for example, a polygon or a circle, that is superimposed over a map. During a category search, if the category matches one of the business categories having sponsors with ads 48 and 76, that have not already reached their cap amount, the search engine server 16 will center the geographic region of consideration on the center point of the coverage area. Any sponsor having a business location within the geographic region of consideration, and not having already reached their cap amount, will have the opportunity to have the position of its ad on the search provider's web page 24 optimized, as discussed below. The geographic region of consideration can take the form of a polygon when the geographic region of consideration approximates the geographic region associated with one or more zip codes, or the geographic region defined by a specific name, e.g., Soho in New York City, or the Westside in Los Angeles. Also, the geographic region of consideration can result from the overlap between two or more coverage areas, e.g., the overlap of a polygon and a circle.

The dimensions of the geographic region of consideration are different for different business categories, because it is expected that the geographic density of businesses within one business category is different from that of another business category. For example, a user would expect a higher geographic density of restaurants than museums in a city. Market multiplier factors are applied to the dimensions of the geographic region of consideration to adjust the size of the geographic region of consideration for each business category. For example, a market multiplier factor of 0.25 is applied to the radius of each circular geographic region of consideration for each business category in New York City, because of the high density of businesses within that city. Thus, if the normal radius for a geographic region of consideration for Italian restaurants is 4 miles, in New York City, the radius multiplied by the market multiplier factor is less, e.g., 1 mile. In other spread out markets, e.g., an agricultural region, the market multiplier factor would be larger than 1, and thus, offer an expanded circular geographic region of consideration. For example, if the market multiplier factor is 1.5 and the normal radius is 4 miles, then the radius for the circular geographic region of consideration would be 6 miles.

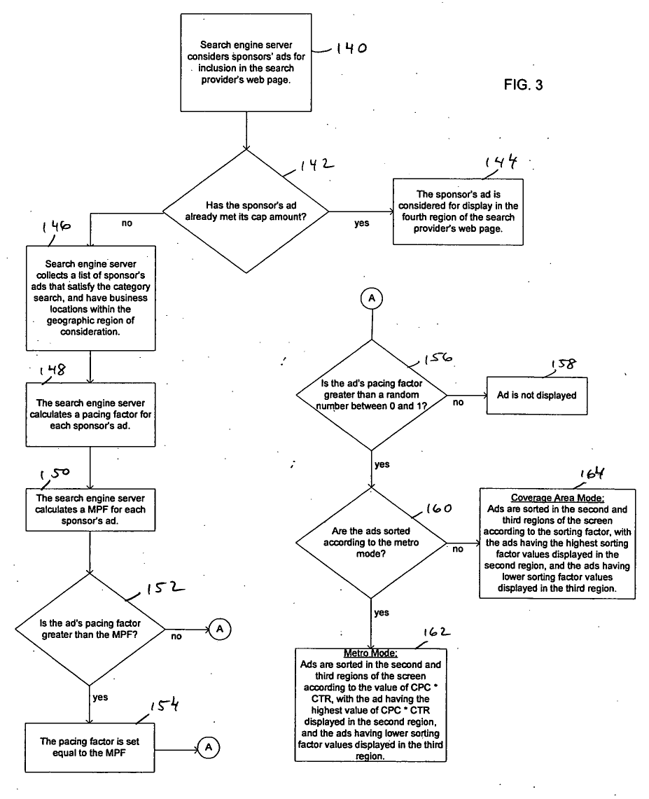

Referring to FIG. 3, during the first two steps 140 and 142 of the optimization process, the search engine server 16 considers sponsors' ads 48 and 76 for inclusion in the search provider's web page 24, and determines whether each sponsor's ad has already met its cap amount, i.e., the links 52 and 78 associated with the sponsor's ad have not received a predetermined number of clicks within a predetermined period of time so as to expend the cap amount. In the third step 144 of the optimization process, if the sponsor's ad already has received enough clicks within a predetermined time period to reach the cap amount, then, the sponsor's ad will be considered for display only in the fourth region 82 of the web page along with non-sponsor ads 112. In embodiments of the present invention, a sponsor will be contacted when its ad has met its cap amount, so that the sponsor can increase its cap amount and maintain the possibility of having its ad display location on the web page optimized in either the second or third regions 46 and 72, respectively, of the web page as discussed below.

In the fourth step 146 of the optimization process, the search engine server 16 collects a list of 30 sponsors' ads 48 and 76 that satisfy the following: the sponsors' ads are associated with the selected business category, and the sponsors' business locations are located within the geographic region of consideration. The sponsors' ads that do not satisfy these two conditions are not included on the list. The sponsors' ads that satisfy these conditions will be considered by the search engine server for display in either the second or third regions 46 and 72, respectively, of the search provider's web page 24.

Referring to the fifth step 148 of the optimization process, whether a sponsor's ad 48 and 76 is considered for display within either of the second or third regions 46 and 72, respectively, of the search provider's web page 24 is influenced by a pacing factor, which is calculated by the search engine server at the end of every time unit, e.g., day or hour. The equation for the pacing factor is as follows:

$$\begin{matrix}Pacing \\ Factor\end{matrix} = 1 - \frac{Accrued Debt}{Cap Amount} * \frac{Billing Cycle Time}{Billing Cycle Time Used} \\ where \text{:}$$

$$Cap Amount = \begin{matrix}the maximum amount of money that the sponsor \\ can expend during a specified time period , \\ e . g . , \$2 \text{,} 000 per month for the ad ;\end{matrix}$$

$$\begin{matrix}Accrued Debt = the amount of clicks that the links 52 \\ in the sponsor ' s ad have received since \\ the last billing cycle multiplied by the \\ cost \text{-} per \text{-} click , e . g . , 10 ¢ per click ( thus , \\ the accrued debt equals the total fee \\ due to the search provider ) ; \\ \begin{matrix}Billing Cycle \\ Time\end{matrix} = the total amount of time , e . g . , the number \\ of days or hours , in the billing cycle ; and \\ \begin{matrix}Billing Cycle \\ Time Used \end{matrix} = the amount of time , e . g . , number of days \\ or hours that have already elapsed since the \\ beginning of the billing cycle .\end{matrix}$$

Accordingly, at the beginning of a billing cycle, the value of the pacing factor is one. During the billing cycle, the value of the pacing factor approaches zero as the accrued debt approaches the cap amount and the billing cycle time used approaches the billing cycle time. The pacing factor is used to regulate and evenly distribute advertising exposure on the search provider's web page across as many sponsors as possible during each billing cycle. The pacing factor also is used in an attempt to make sure that each sponsor's ad reaches its cap amount by the end of the billing cycle, instead of early in the billing cycle.

In the sixth step 150 of the optimization process, the search engine server 16 calculates a maximum pacing factor (“MPF”) for each sponsor's ad 48 and 76 according to the following equation:

$$\begin{matrix}Maximum \\ Pacing Factor\end{matrix} = \frac{\begin{matrix}Average Available Cap of the \\ Top \text{-} Ranked Sponsors ' Ads\end{matrix}}{Peak Daily Revenue of the Sponsor ' s Ad}$$

$$where \text{:}$$

$$\begin{matrix}Average Avalable Cap of the \\ Top \text{-} Ranked Sponsors ' Ads\end{matrix} = \begin{matrix}the average value of the accrued \\ debt subtracted from the cap \\ amount for all of the {sponsors}^{'} \\ ads within a specific business \\ category ; and\end{matrix} \\$$

$$\begin{matrix}Peak Daily Revenue \\ of the Sponsor ' s Ad\end{matrix} = \begin{matrix}the Peak Daily Revenue , i . e . , the peak value \\ of the CPC times the number of clicks on \\ the ad ' s link ( s ) 52 and 78 per day , during \\ the current billing cycle .\end{matrix}$$

Thus, as the value of the average available cap of the sponsors' ads within a specific business category decreases throughout the billing cycle, the MPF reduces in value. Also, if the peak daily revenue associate with a particular sponsor's ad is high, the MPF reduce in value.

In the seventh step 152 of the optimization process, the search engine server 16 compares the pacing factor to the MPF for each sponsor's ad 48 and 76. If the ad's pacing factor is greater than the MPF value, then the pacing factor is set equal to the MPF in the eighth step 154. Accordingly, the MPF is a limiting value on the value of the pacing factor. The MPF in combination with the pacing factor, as discussed below, reduces the chance of a sponsor's ad being displayed in the search provider's web page, and thus, diminishes the likelihood of a user clicking on the sponsor's ad, when the accrued debt approximates the cap amount.

In the ninth step 156 of the optimization process, the search engine server 16 compares the pacing factor for each of the sponsors' ads 48 and 76 with a random number, having a value between zero and one, that is generated by the search engine server for each sponsor's ad. In the tenth step 158 of the optimization process, if the random number is greater than the pacing factor, that sponsor's ad is not considered for display in the search provider's web page 24. Thus, the pacing factor, in combination with the MPF value described above, is utilized by the search engine server to reduce the likelihood of a user viewing a sponsor's ad on the search provider's web page and subsequently clicking on links 52 and 78 included in the sponsor's ad when the ad has already met its cap amount.

When the random number is less than the ad's pacing number, the position of the sponsor's ad 48 and 76 in the second and third regions 46 and 72, respectively, of the search provider's web page 24 is determined by the search engine server 16 using one of two different methods, as indicated in the eleventh, twelfth, and thirteenth steps 160, 162, and 164, respectively, of the optimization process. In one embodiment of the present invention, a method referred to as the “metro mode,” the twelfth step 162 of the optimization process, is used.

In the metro mode, the search engine server 16 sorts the sponsors' ads 48 and 76 according to the value of the CPC multiplied by the CTR for each ad. The CPC*CTR value is an approximate monetary yield for a sponsor's ad. The higher the value of CPC*CTR, the higher the ad is ranked in the metro mode sorting method. The sponsors' ads having the top values of CPC*CTR are included on the search provider's web page 24 in two separate groups. A first group of sponsors' ads is included in the second region 46 of the web page, and a second group of sponsors' ads is included in the third region 72 of the web page. The number of sponsors' ads included in the second and third regions of the web page can vary. For example, as shown in FIG. 2, in the metro mode, the sponsor's ads having the top ten values of CPC*CTR are included in the second and third regions, with the four ads having the top values of CPC*CTR value located in the second region, and the six ads having the next highest values of CPC*CTR located in the third region.

In another embodiment of the present invention, after the pacing factor for each of the 30 sponsors' ads 48 and 76 is compared to the random number 146, and the random number is less than the pacing number, the position of the sponsors' ads in the second and third regions 46 and 72, respectively, of the search provider's web page 24 is determined by the search engine server 16 using the “coverage area mode,” the thirteenth step 164 of the optimization process. In the coverage area mode, the search engine server sorts the sponsor ads according to a sorting factor, the equation for which follows:

$$\begin{matrix}Sorting \\ Factor\end{matrix} = \frac{CPC * CTR}{Distance from the Center Point + Market Distance Constant}$$

$$where \text{:}$$

$$Distance from the Center Point = \begin{matrix}the distance between the sponsor ' s \\ business location and the center \\ point of the conceptual geographic \\ region of consideration , and\end{matrix}$$

$$\begin{matrix}Market Distance \\ Constant ( “ MDC ” )\end{matrix} = \begin{matrix}the approximate distance of a two \\ minute cab ride in the market where the \\ business is located ( the value of the \\ MDC for each market is stored in the \\ search engine server ) .\end{matrix}$$

The higher the value of the sorting factor, the higher the sponsor's ad is ranked in the coverage area mode sorting method. The sponsors' ads having the top values of the sorting factor are included on the search provider's web page in two separate groups. A first group of sponsors' ads is included in the second region of the web page, and a second group of sponsors' ads is included in the third region of the web page. As mentioned previously, the number of sponsors' ads included in the second and third regions of the web page can vary. For example, as shown in FIG. 2, in the coverage area mode, the sponsors' ads having the top ten sorting factor values are included in the second and third regions, with the four ads having the top sorting factor values located in the second region, and the six ads having the next highest sorting factor values located in the third region.

In additional embodiments, the search engine server 16 increases the CTR value for a sponsor's ad 48 and 76, in either the metro mode sorting method or the coverage area mode sorting method, by 50% when the ad has the following: 1) an above average value of CTR when compared to the other sponsor's ads being considered for placement in the second and third regions 46 and 72, respectively, of the search provider's web page 24; and 2) the value of the cap amount subtracted from the accrued debt for the sponsor's ad is greater than a fixed dollar amount, which periodically, e.g., on a daily basis, is adjusted based upon forecasting done by the search provider. Thus, by increasing the CTR value by 50%, the search engine server promotes the position of the sponsors' ads having a large value of cap amount to expend.

The ads 84 that are selected for display in the fourth region 82 of the search provider's web page 24 are determined based on the following process. First, a list of 200 ads for non-sponsors and sponsors that have already met their cap amount, i.e., the total fee due to the search provider equals the cap amount, is created by the search engine server 16 that satisfy the category search. Second, this list of ads is sorted based on the distance 100 between the business location and the center point of the geographic region of consideration, such that the ad having the shortest distance is positioned at the top of the list. For example, as shown in FIG. 2, nine ads, including a sponsor ad 104 and non-sponsor ads 112, that satisfy the category search and have the shortest distance between their respective business locations and the center point are displayed in the fourth region. In other embodiments of the present invention, instead of sorting the ads based on distance, the ads can be sorted based on their rating values 102.

After the position of the sponsors' ads 48 and 76 have been optimized in the second and third regions 46 and 72, respectively, of the search provider's web page 24, either by use of the metro mode or the coverage area mode, and the position of the sponsors' ads 104 that have reached their cap and non-sponsors' ads 112 have been determined in the fourth region 82, the information regarding each ad and its location on the search provider's web page is returned to the user's computer 12 for display on the user computer's monitor (not shown). While four ads are displayed in the second region, six ads are displayed in the third region, and nine ads are displayed in the fourth regions of the web page in FIG. 2, more or less ads can be displayed in each region. Also, there can be instances when the program is configured to display ads in only one or two of the second, third, and fourth regions of the web page, instead of all three regions.

The above optimization process is performed by the search engine server 16 in real time. The optimization process results in a search provider's web page 24 where sponsor ads 48 and 76, which have not met the cap amount, are prominently positioned in the either the second or third regions 46 and 72, respectively, of the web page, and the sponsors' ads 104 that have reached the cap and non-sponsor ads 112 are displayed in the fourth region 82. Since the sponsors ads are displayed in a more prominent position on the search provider's web page, in the second and third regions, the optimization process increases the likelihood of a user clicking on those sponsors' ad. Thus, the optimization process also increases the likelihood of revenue maximization for each sponsor's ad that is displayed in the second and third regions of the web page. Accordingly, the present invention arranges the sponsors' ads on the search provider's web page in hopes of maximizing the click-through traffic for each ad, and, via the pacing factor, influences the position of the sponsors' ads that are displayed in hopes of maximizing the revenue generation for the search provider across all possible sponsors' ads.

A sponsor's ad 48 and 76 can rotate through to various positions on the search provider's web page 24 depending upon the ad's relevancy to the user's category search, and how well the ad is performing against monthly advertising objectives, e.g., the ad's cap amount, CPC, CTR, and geographical considerations related to the location of the sponsor's business.

If a category search does not match one of the sales categories having sponsors below their cap amount, then the second and third regions 46 and 72, respectively, of the search provider's web page 24 will not be displayed, and only the first and fourth regions 26 and 82, respectively, will be displayed. Because the second and third regions are not displayed, the fourth region is expanded to take up more of the web page than that shown in FIG. 2. Because of this additional space, an additional number of ads 84 can be displayed in the fourth region.

As discussed previously, when the user clicks on an ad's link 52, 78, and 86 with a computer input device (not shown), e.g., mouse, to initiate a web page retrieval request, the search engine server 16 logs the click for billing purposes. In particular, after each click, a predetermined amount of money either is deducted from the sponsor's prepaid account, or is recorded to the sponsor's account. Such a billing scheme is attractive to sponsors, since the sponsor is not billed unless the ad 48 and 76 receives click-through traffic. The billing rate is the CPC rate contracted for with a sponsor. At the end of a billing cycle, e.g., the end of a month, a bill is calculated for each sponsor, which equals the number of clicks multiplied by the CPC for each of the sponsor's ads, with the maximum amount of the bill set to the cap amount. It is possible to have more than one billing rate for a single ad during a billing cycle, because the number of clicks and the billing rate are stored by the search engine server 16 on a daily basis. Data regarding each sponsor's ad is updated on a regular predetermined basis, for example, on a nightly basis, as part of a background task. Therefore, the data updating process does not adversely affect the overall speed/performance of the search engine server.

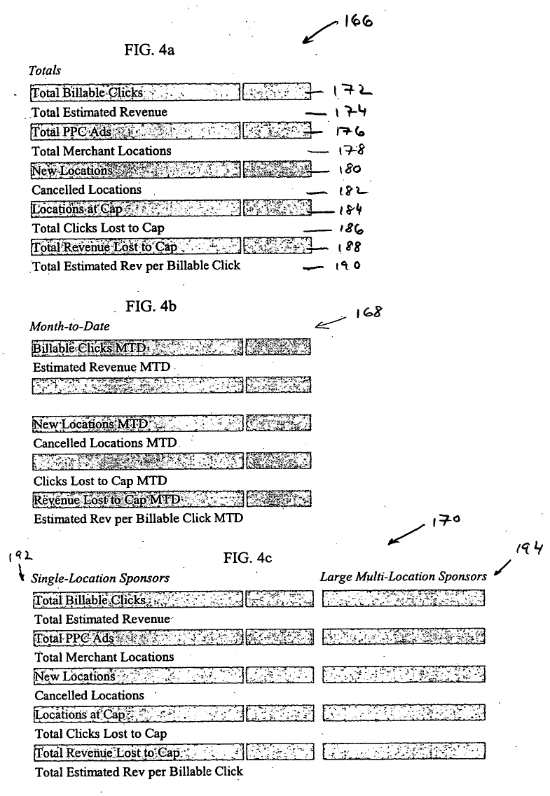

FIGS. 4a-c are tables 166-170, respectively, that can be generated from the data included in the advertiser database stored in the search engine server 16. In particular, the tables shown in FIGS. 4a-c, include the following: the total number of billable clicks 172, which is the total number of times a sponsor's ad 48 and 72 was clicked on; the total estimated revenue 174, which equals CPC*CTR for the sponsors' ads; the total PPC ads 176, where PPC stands for pay-per-click; the total merchant locations 178, which is the total number of sponsors during the last billing cycle; the number of new locations 180, which is the total number of sponsors added during the current, active billing cycle; the number of cancelled locations 182, which is the total number of sponsors that cancelled their service with the search provider during the past billing cycle; the number of locations at cap 184, which is the total number of sponsors' ads that are at their respective cap amounts; the total clicks lost to cap 186, which is the total number of times that a sponsor's ad was clicked on when the sponsor's ad was at its cap amount; the total revenue lost to cap 188, which is the total amount of revenue that the search provider lost because users clicked on links 52 and 78 in a sponsor's ad after the cap amount was reached; and the total estimated revenue per billable click 190, which is total average amount of revenue generated for the search provider as a result of user clicks on links included in the second and third regions 46 and 72, respectively, of the search provider's web page 24.

As shown in FIG. 4c, the sponsor data can be separated based on sponsor type, e.g., single-location sponsors 192 vs. multiple-location sponsors 194. A single-location sponsor is a sponsor that has only one business location. In contrast, a multiple-location sponsor has more than one business location. Thus, the data can be analyzed in many different ways, in order to maximize both the sponsors' advertising efficiency and the search provider's revenue.

The system and method of the present invention can be implemented using one or more software programs, which are stored as executable instructions on a computer-readable storage medium (not shown) in the search engine server 16. In one embodiment, the system is embodied in a computer-readable storage medium such as a CDROM, hard disk drive, memory, or other storage device. The program can be in source or object code, or another format. In accordance with one embodiment, excerpts of code for one embodiment of the present invention are attached hereto in Appendix A.

Advantageously, the present invention's optimization process maximizes the sponsor's advertising efficiency by billing the sponsor only after a user has clicked on a link 52 and 78 associated with the sponsor's ad 48 and 76. Also, the present invention only displays a sponsor's ad in a prominent position, in the second and third regions 46 and 72, respectively, on the search provider's web page 24 when the ad is highly pertinent to the user's search, and likely to be clicked on by the user. In addition, the present invention monitors the click-through history for each sponsor's ad, and can provide output to aid sponsors in their assessment of their ad's advertising efficiency. Thus, the present invention increases the search providers advertising efficiency, and increases the search providers revenues.

1. A system comprising:
a search engine server having a first computer-readable medium containing information for a search provider's web page;
an advertiser server coupled to the search engine server and having a second computer-readable medium containing information for an advertiser's web page; and
a user computer coupled to the search engine server and the advertiser's server, the user computer having a monitor that is configured to display web pages;
wherein the search provider's web page, when displayed on the monitor, includes ads with each ad including a link to an advertiser's web page, where an advertiser is an entity whose ad is displayed on the search provider's web page, and a position of each ad on the search provider's web page is dependent upon whether the search provider is due payment from the advertiser.

2. The system according to claim 1, wherein the position of the ad on the search provider's web page is dependent upon whether a link included in an ad has received a predetermined number of clicks within a predetermined period of time.

3. The system according to claim 1, wherein;
a sponsor is an advertiser that has a financial agreement with the search provider regarding the inclusion of the sponsor's ad on the search provider's web page;
a non-sponsor is an advertiser whose ad is displayed on the search provider's web page free of charge; and
non-sponsors' ads are displayed in a region of the search provider's web page below another region of the search provider's web page where sponsors' ads are displayed.

4. The system according to claim 3, wherein the search provider is due a fee from a sponsor every time a user selects a link associated with the sponsor's ad displayed on the search provider's web page.

5. The system according to claim 3, wherein the sponsor's ad has associated with it a cap amount that is the maximum amount of money that a sponsor can be billed by the search provider for the sponsor's ad within a billing cycle.

6. The system according to claim 5, wherein a location where the sponsor's ad is displayed on the search provider's web page is influenced by a difference between the cap amount and a total accrued debt owed by the sponsor to the search provider for the sponsor's ad.

7. The system according to claim 6, wherein the sponsor's ad is located within the region of the search provider's web page with non-sponsors' ads when the total accrued debt owed by the sponsor to the search provider for the sponsor's ad equals the cap amount.

8. The system according to claim 5, wherein the sponsor can change the cap amount.

9. A first computer-readable medium included in a search engine server, wherein the first computer-readable medium contains a program configured to interact with a database stored in a second computer-readable medium also included in the search engine server, wherein the search engine server is configured to couple to an advertiser server having a third computer-readable medium containing information for an advertiser's web page, and wherein the search engine server is configured to couple to a user computer having a monitor that is configured to display a web page, the program comprising information used to generate a search provider's web page, wherein:
the search provider's web page is displayed on the monitor and includes ads that are stored in the database, with each ad including a link to an advertiser's web page, where an advertiser is an entity whose ad is displayed on the search provider's web page, and a sponsor is an advertiser that has a financial agreement with the search provider regarding the inclusion of the sponsor's ad on the search provider's web page;
the search provider is due a fee from the sponsor every time a user selects a link included in the sponsor's ad displayed on the search provider's web page;
the sponsor's ad has associated with it a cap amount that is the maximum amount of money that a sponsor can be billed by the search provider for the sponsor's ad within a billing cycle; and
a location where the sponsor's ad is displayed on the search provider's web page is influenced by a difference between the cap amount and a total accrued debt owed by the sponsor to the search provider for the sponsor's ad.

10. The program according to claim 9, wherein:
a non-sponsor is an advertiser whose ad is displayed on the search provider's web page free of charge; and
non-sponsors' ads are displayed in a region of the search provider's web page below another region of the search provider's web page where sponsors' ads are displayed.

11. The program according to claim 10, wherein the sponsor's ad is located within a region of the search provider's web page with non-sponsors' ads when the total accrued debt owed by the sponsor to the search provider for the sponsor's ad equals the cap amount.

12. The program according to claim 9, wherein the sponsor can change the cap amount.

13. A method for organizing ads on a search provider's web page, wherein information related to the search provider's web page is stored in a first computer-readable medium included in a search engine server, wherein the information related to the search provider's web page is configured to interact with advertiser information in an advertiser database stored in a second computer-readable medium that also is included in the search engine server, wherein an advertiser is an entity having an ad that is displayed on the search provider's web page, wherein the search engine server is configured to couple to an advertiser server having a third computer-readable medium containing information for an advertiser's web page, wherein the search engine server is configured to couple to a user computer having a monitor that is configured to display a web page, and wherein each sponsor's ad has associated with it a cap amount that is the maximum amount of money that a sponsor can be billed by the search provider for the sponsor's ad within a billing cycle, the method comprising:
performing a category search using the search engine server for ads included in the advertiser database;
creating a list of sponsors' ads based on results of the category search; and
positioning the sponsors' ads on the search provider's web page based on a difference between the cap amount and a total accrued debt owed by the sponsor to the search provider for the sponsor's ad.

14. The method according to claim 13, further comprising:
calculating a geographic region of consideration; and
removing all sponsor ads from the list of sponsors' ads when the respective sponsor's business location is outside of the geographic region of consideration.

15. The method according to claim 14, wherein the geographic region of consideration is a circle having a center point and a radius, and the radius is multiplied by a market multiplier factor that varies as a function of a location of the center point.

16. The method according to claim 14, further comprising:
calculating a pacing factor; and
comparing a random number, having a value between zero and one, to the pacing factor for each sponsor's ad and displaying the sponsor's ad on the search provider's web page only if the pacing factor is greater than the random number.

17. The method according to claim 16, further comprising sorting the sponsors' ads and displaying the sponsors' ads on the search provider's web page according to the cost-per-click multiplied by the click-through rate associated with each sponsor's ad.

18. The method according to claim 16, further comprising:
calculating a sorting factor; and
sorting the sponsors' ads and displaying the sponsors' ads on the search provider's web page according to the sorting factor.

19. The method according to claim 13, wherein a non-sponsor is an advertiser whose ad is displayed on the search provider's web page free of charge.

20. The method according to claim 19, further comprising displaying non-sponsors' ads in a region of the search provider's web page below another region of the search provider's web page where sponsors' ads are displayed.

21. The method according to claim 20, further comprising positioning the sponsor's ad within a region of the search provider's web page with non-sponsors' ads when the total accrued debt owed by the sponsor to the search provider for the sponsor's ad equals the cap amount.
